(19) United States
(12) Patent Application Publication
(10) Pub. No.: US 2025/0031224 A1
(43) Pub. Date: Jan. 23, 2025

(54) METHODS AND APPARATUSES OF RESOURCE ALLOCATION FOR SIDELINK COMMUNICATION

(71) Applicant: LENOVO (BEIJING) LIMITED, Beijing (CN)

(72) Inventors: Xin GUO, Beijing (CN); Haipeng LEI, Beijing (CN); Zhennian SUN, Beijing (CN); Xiaodong YU, Beijing (CN)

(21) Appl. No.: 18/713,915

(22) PCT Filed: Nov. 29, 2021
(86) PCT No.: PCT/CN2021/134116

§ 371 Date: May 28, 2024

(51) Int. Cl. H04W 72/25; H04W 72/0446

(52) U.S. Cl. CPC H04W 72/25; H04W 72/0446

(57) ABSTRACT

Embodiments of the present disclosure relate to methods and apparatuses of resource allocation for sidelink (SL) communication. According to an embodiment of the present disclosure, a base station (BS) can include: a transmitter configured to: transmit a scheduling grant associated with a resource pool to a user equipment (UE), wherein the scheduling grant indicates a first set of resources for a sidelink transmission; and transmit a sidelink pre-emption indication message to the UE, wherein the sidelink pre-emption indication message comprises a sidelink pre-emption indicator (SL-PI) indicating that at least one second set of resources of the first set of resources is pre-empted, wherein each second set of resources is represented by a pair of sub-slot(s) and sub-channel(s).

### TECHNICAL FIELD

Embodiments of the present application are related to wireless communication technology, and more particularly, related to methods and apparatuses of resource allocation for sidelink (SL) communication.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

3GPP 5G networks are expected to increase network throughput, coverage and reliability and to reduce latency and power consumption. With the development of 3GPP 5G networks, various aspects need to be studied and developed to perfect the 5G technology. Currently, details regarding resource allocation for sidelink communication need to be further discussed in 3GPP 5G technology.

### SUMMARY OF THE APPLICATION

Embodiments of the present application at least provide a technical solution of resource allocation for sidelink communication.

According to some embodiments of the present application, a method performed by a BS may include: transmitting a scheduling grant associated with a resource pool to a UE, wherein the scheduling grant indicates a first set of resources for a sidelink transmission; and transmitting a sidelink pre-emption indication message to the UE, wherein the sidelink pre-emption indication message comprises a sidelink pre-emption indicator (SL-PI) indicating that at least one second set of resources of the first set of resources is pre-empted, wherein each second set of resources is represented by a pair of sub-slot(s) and sub-channel(s).

In some embodiments of the present application, a sub-slot pattern of the sub-slot(s) associated with a second set of resources is indicated by a sub-slot pattern index which is included in a resource pool configuration for the resource pool.

In some embodiments of the present application, the method may further include transmitting a parameter indicating a number of consecutive sub-channels included in a second set of resources.

In some embodiments of the present application, the parameter indicating the number of consecutive sub-channels is transmitted in downlink control information (DCI) carrying the sidelink pre-emption indication message or in a resource pool configuration for the resource pool.

In some embodiments of the present application, the method may further include transmitting a parameter indicating a number of consecutive sub-slots included in a second set of resources.

In some embodiments of the present application, the parameter indicating the number of consecutive sub-slots is transmitted in downlink control information (DCI) carrying the sidelink pre-emption indication message or in a resource pool configuration for the resource pool.

In some embodiments of the present application, the sidelink pre-emption indication message is transmitted in at least one of the following signalings: a UE-specific DCI for the UE; a group-common DCI for a group of UEs including the UE; a medium access control (MAC) control element (CE); or a radio resource control (RRC) signaling.

In some embodiments of the present application, the SL-PI is a bitmap, wherein each bit of the bitmap indicates whether a second set of resources is pre-empted.

In some embodiments of the present application, the SL-PI is at least one indication indicating the at least one second set of resources.

In some embodiments of the present application, the sidelink pre-emption indication message further comprises at least one of followings: an SL cancellation indication; a permitted power level for an intended SL transmission of the UE; and an SL puncture indication.

In some embodiments of the present application, each sub-slot is used to transmit integer number of code block groups (CBGs) of a transport block (TB) from the UE.

In some embodiments of the present application, the method may further include: transmitting a CBG transmission indication which indicates to enable or disable a CBG-based transmission for the resource pool.

In some embodiments of the present application, the CBG transmission indication is transmitted in DCI carrying the sidelink pre-emption indication message or in a resource pool configuration for the resource pool.

According to some other embodiments of the present application, a method performed by a UE may include: receiving a scheduling grant associated with a resource pool to a UE, wherein the scheduling grant indicates a first set of resources for a sidelink transmission; and receiving a sidelink pre-emption indication message to the UE, wherein the sidelink pre-emption indication message comprises a SL-PI indicating that at least one second set of resources of the first set of resources is pre-empted, wherein each second set of resources is represented by a pair of sub-slot(s) and sub-channel(s).

In some embodiments of the present application, a sub-slot pattern of the sub-slot(s) associated with a second set of resources is indicated by a sub-slot pattern index which is included in a resource pool configuration for the resource pool.

In some embodiments of the present application, the method may further include receiving a parameter indicating a number of consecutive sub-channels included in a second set of resources.

In some embodiments of the present application, the parameter indicating the number of consecutive sub-channels is received in DCI carrying the sidelink pre-emption indication message or in a resource pool configuration for the resource pool.

In some embodiments of the present application, the method may further include receiving a parameter indicating a number of consecutive sub-slots included in a second set of resources.

In some embodiments of the present application, the parameter indicating the number of consecutive sub-slots is received in DCI carrying the sidelink pre-emption indication message or in a resource pool configuration for the resource pool.

In some embodiments of the present application, the sidelink pre-emption indication message is received in at least one of the following signalings: a UE-specific DCI for the UE; a group-common DCI for a group of UEs including the UE; a MAC CE; or an RRC signaling.

In some embodiments of the present application, the SL-PI is a bitmap, wherein each bit of the bitmap indicates whether a second set of resources is pre-empted.

In some embodiments of the present application, the SL-PI is at least one indication indicating the at least one second set of resources.

In some embodiments of the present application, each sub-slot is used to transmit integer number of CBGs of a TB from the UE.

In some embodiments of the present application, the method may further include: receiving a CBG transmission indication which indicates to enable or disable a CBG-based transmission for the resource pool.

In some embodiments of the present application, the CBG transmission indication is received in DCI carrying the sidelink pre-emption indication message or in a resource pool configuration for the resource pool.

In some embodiments of the present application, the sidelink pre-emption indication message further comprises at least one of followings: an SL cancellation indication; a permitted power level for an intended SL transmission of the UE; and an SL puncture indication.

In some embodiments of the present application, the method may further include: in response to receiving the SL cancellation indication, cancelling an intended SL transmission of the UE in at least one slot including the at least one second set of resources.

In some embodiments of the present application, the method may further include: in response to receiving the permitted power level, transmitting an intended SL transmission of the UE in at least one slot including the at least one second set of resources based on the permitted power level.

In some embodiments of the present application, the method may further include: determining to perform a retransmission of an SL transmission based on the SL-PI.

In some embodiments of the present application, the method may further include: in response to receipt of the SL cancellation indication, cancelling an intended SL transmission in the at least one second set of resources.

In some embodiments of the present application, the method may further include: in response to receipt the permitted power level, transmitting an intended SL transmission in the at least one second set of resources based on the permitted power level.

In some embodiments of the present application, the method may further include: in response to receipt of the SL puncture indication, puncturing an intended SL transmission of the UE in the at least one second set of resources.

Some embodiments of the present application also provide a BS including: a transmitter configured to: transmit a scheduling grant associated with a resource pool to a UE, wherein the scheduling grant indicates a first set of resources for a sidelink transmission; and transmit a sidelink pre-emption indication message to the UE, wherein the sidelink pre-emption indication message comprises an SL-PI indicating that at least one second set of resources of the first set of resources is pre-empted, wherein each second set of resources is represented by a pair of sub-slot(s) and sub-channel(s).

Some other embodiments of the present application also provide a UE including: a receiver configured to: receive a scheduling grant associated with a resource pool, wherein the scheduling grant indicate a first set of resources for a sidelink transmission; and receive a sidelink pre-emption indication message, wherein the sidelink pre-emption indication message comprises an SL-PI indicating that at least one second set of resources of the first set of resources is pre-empted, wherein each second set of resources includes is represented by a pair of sub-slot(s) and sub-channel(s); a processor coupled to the receiver; and a transmitter coupled to the processor.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates two exemplary sidelink slot patterns according to some embodiments of the present application;

FIG. 3 illustrates an exemplary sidelink sub-slot pattern according to some embodiments of the present application;

FIG. 4 illustrates another exemplary sidelink sub-slot pattern according to some other embodiments of the present application;

FIG. 5 illustrates an exemplary flowchart of a method for resource allocation according to some embodiments of the present application;

FIG. 6 illustrates an exemplary resource allocation according to some embodiments of the present application;

FIG. 7 illustrates examples of SL-PI according to some embodiments of the present application;

FIG. 8 illustrates exemplary TB segmentation according to some embodiments of the present application;

FIG. 9 illustrates an exemplary CBG-based transmission according to some embodiments of the present application;

FIG. 10 illustrates an exemplary transmission of sidelink pre-emption indication message according to some embodiments of the present application;

FIG. 11 illustrates another exemplary transmission of sidelink pre-emption indication message according to some other embodiments of the present application;

FIG. 12 illustrates yet another exemplary transmission of sidelink pre-emption indication message according to some other embodiments of the present application;

FIG. 13 illustrates yet another exemplary transmission of sidelink pre-emption indication message according to some other embodiments of the present application; and

FIG. 14 illustrates a simplified block diagram of an exemplary apparatus for resource allocation according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

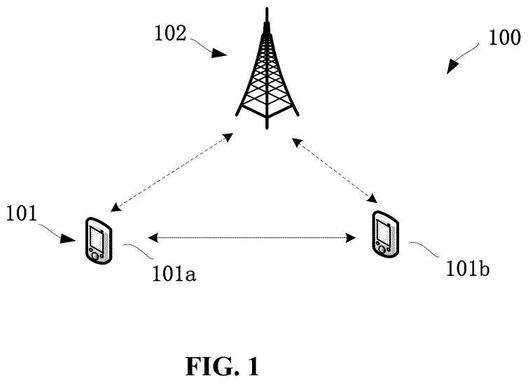

FIG. 1 illustrates an exemplary wireless communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE is a pedestrian UE (P-UE or PUE) or a cyclist UE. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via LTE or NR Uu interface. Moreover, UE(s) 101 may work in a wider Internet-of-Thing (IoT) or Industrial IoT (IIoT) scenario with increased demand(s) of low air-interface latency and/or high reliability to be addressed, which includes such as factory automation, electrical power distribution, and/or transport industry.

In some embodiments of the present application, each of UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in UE(s) 101 may be varied and not limited.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, PC5 interface as defined in 3GPP TS 23.303. UE 101a may transmit information or data to other UE(s) within the sidelink communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols.

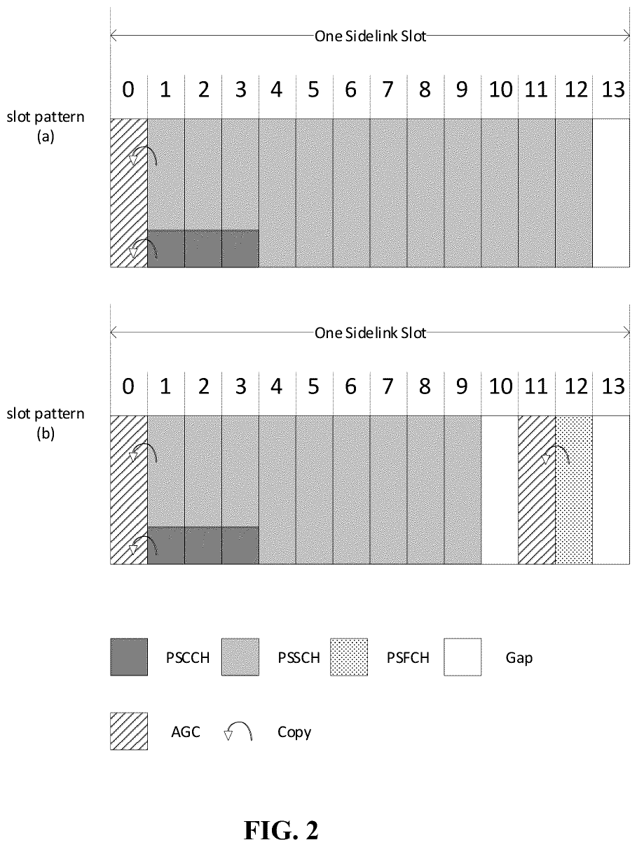

In general, supporting for a new radio (NR) SL is firstly introduced in 3GPP Rel-16. Although the resource pool configuration has a slot-based granularity in the time domain, this does not preclude the case in which only a limited set of consecutive symbols within a sidelink slot is actually available for sidelink communication. The limited set of consecutive symbols can be configured by the first symbol of the set of consecutive symbols available for sidelink communication and the number of consecutive symbols available for sidelink communication. Without loss of generality, this application only illustrates examples where all 14 OFDM symbols within a sidelink slot are available for sidelink communication. As per NR sidelink slot specified in 3GPP Rel-16, the first of the available OFDM symbols for sidelink communication of a sidelink slot is a copy of the second of the available OFDM symbols for sidelink communication of the sidelink slot; and the first of the available OFDM symbols for sidelink communication is used for an automatic gain control (AGC) purpose. The operation of AGC is performed by a UE when receiving a signal to determine the amplification degree, and thus, the UE can adjust the gain of the receiver amplifier to fit the power of the received signal. The specific examples are shown in FIG. 2 as below.

FIG. 2 illustrates two exemplary sidelink slot patterns according to some embodiments of the present application. As shown in FIG. 2, the two exemplary sidelink slot patterns may be referred to as slot pattern (a) and slot pattern (b). In the slot pattern (a) and slot pattern (b), one sidelink slot includes 14 OFDM symbols in total, i.e., OFDM symbol #0 to OFDM symbol #13. OFDM symbol #0 is used for AGC by repeating the first OFDM symbol (i.e., OFDM symbol #1) carrying physical sidelink shared channel (PSSCH) and/or physical sidelink control channel (PSCCH) transmissions. The last available OFDM symbol, i.e., OFDM symbol #13, is always used as a guard symbol. In addition, OFDM symbol #1, OFDM symbol #2, and OFDM symbol #3 are used to carry PSSCH and PSCCH transmissions. OFDM Symbol #4 to OFDM symbol #9 are used to carry PSSCH transmissions. An OFDM symbol carrying PSSCH and/or PSCCH transmissions may be named as “a PSSCH and/or PSCCH OFDM symbol”, “a PSSCH and/or PSCCH symbol”, or the like.

In the embodiments of FIG. 2, the difference between slot pattern (a) and slot pattern (b) is OFDM Symbol #10 to OFDM symbol #12. Specifically, in slot pattern (a), OFDM Symbol #10 to OFDM symbol #12 are used to carry PSSCH transmissions. However, in slot pattern (b), the hybrid automatic repeat request (HARQ) feedback is enabled for the sidelink slot, then a physical sidelink feedback channel (PSFCH) transmission is transmitted in the second last available OFDM symbol (i.e., OFDM symbol #12 as shown in slot pattern (b) in FIG. 2) of the sidelink slot. An OFDM symbol carrying a PSFCH transmission may be named as “a PSFCH OFDM symbol”, “a PSFCH symbol”, or the like. One OFDM symbol right prior to the PSFCH symbol may be used as AGC and may comprise a copy of the PSFCH symbol. For example, OFDM symbol #11 as shown in slot pattern (b) in FIG. 2 is used as AGC by repeating the PSFCH symbol #12 as shown in slot pattern (b) in FIG. 2.

In some embodiments, a guard symbol between the PSSCH and/or PSCCH symbol and the PSFCH symbol is needed to provide switching time between “a PSSCH and/or PSCCH reception” and “a PSFCH transmission” (i.e., OFDM symbol #10 as shown in slot pattern (b) in FIG. 2). This implies that, if PSFCH resources are configured for a sidelink slot, this will use a total of three OFDM symbols, including the AGC symbol and the extra guard symbol.

Considering that the AGC setting time occupies only 15 microseconds (i.e., μsec or μs), and the assumption for the necessary transmission/reception (Tx/Rx) switching gap is 13 μsec while the symbol duration for 15 kHz Subcarrier Spacing (SCS) is equal to 66.67 μsec and the symbol duration for 30 kHz SCS is equal to 33.33 μsec, it is inefficient to use a whole symbol working as AGC for some SCS, such as, 15 kHz or 30 kHz.

Currently, in emerging latency critical applications (e.g., a factory automation scenario), lower latency requirements are needed and thus cannot be satisfied by a slot-based sidelink transmission. For example, if SCSs are configured per resource pool and if a desired resource pool is configured with a shorter SCS (such as, 15 kHz or 30 kHz), it is required to reduce the transmission latency for the configured SCS. This implies that, the latency on the resource pool cannot be reduced by applying a longer SCS. Therefore, sub-slot based sidelink slot pattern (or format) is introduced in supporting low latency and high spectrum efficiency sidelink transmission, which comprises the following components such as full symbol (FS), half symbol (HS), and combined symbol (CS).

For instance, following three types of a full symbol are defined.
(1) FS₁ is defined as a full symbol which is for carrying PSSCH and/or PSCCH transmissions.
(2) FS₂ is defined as a full symbol which is for carrying a PSSCH transmission.
(3) FS₃ is defined as a full symbol which is for carrying a PSFCH transmission.

For instance, following four types of a half symbol are defined.
(1) HS₁ is defined as a HS which is “a copy of the first half of the nearest PSSCH and/or PSCCH symbol after the HS” or “a copy of the first half of the nearest PSFCH symbol after the HS”. For example, HS₁ can be used as AGC.
(2) HS₂ is defined as a HS which works as a gap for Tx/Rx switching.
(3) HS₃ is defined as a HS which is “a copy of the second half of the nearest PSSCH and/or PSCCH symbol before the HS” or “a copy of the second half of the nearest PSFCH symbol before the HS”. For example, HS₃ can be used for reliability improvement.
(4) HS₄ is defined as a HS carrying extra information by transmitting a preamble sequence. The information carried in HS₄ can be used for supporting a sub-slot based transmission. For example, HS₄ can be used for increasing spectrum efficiency. Or, HS₄ can be used for padding a symbol.

For instance, following four types of a combined symbol are defined.
(1) CS₁ is defined as comprising two half symbols, in which the first half of the combined symbol is HS₁, and the second half of the combined symbol is HS₄.
(2) CS₂ is defined as comprising two half symbols, in which the first half of the combined symbol is HS₃, and the second half of the combined symbol is HS₂.
(3) CS₃ is defined as comprising two half symbols, in which the first half of the combined symbol is HS₂, and the second half of the combined symbol is HS₁.
(4) CS₄ is defined as comprising two half symbols, in which the first half of the combined symbol is HS₄, and the second half of the combined symbol is HS₂.

Currently, for instance, following two types of sidelink sub-slots are defined.
(1) Sub-slot type SSA does not comprise symbol(s) of a PSFCH transmission. That is, SSA comprises only “PSSCH and/or PSCCH transmissions” or only “a PSSCH transmission”. Sub-slot type SSA can be further classified as follows:
   a) Sub-slot type SS_{A1} comprises one CS₁, at least one FS₁, and one CS₂.
   b) Sub-slot type SS_{A2} comprises one CS₁, at least one FS₁, and one HS₂.
   c) Sub-slot type SS_{A3} comprises one HS₁, at least one FS₁, and one CS₂.
   d) Sub-slot type SS_{A4} comprises one HS₁, at least one FS₁, and one HS₂.
(2) Sub-slot type SS_{B} does not comprise symbol(s) of PSSCH and/or PSCCH transmissions. That is, SS_{B} comprises only a PSFCH transmission. Sub-slot type SS_{B} can be further classified as follows:
   a) Sub-slot type SS_{B1} comprises one HS₁, at least one FS₃, and one CS₂.
   b) Sub-slot type SS_{B2} comprises one HS₁, at least one FS₃, and one CS₄.
   c) Sub-slot type SS_{B3} comprises one HS₁, at least one FS₃, and one HS₂.

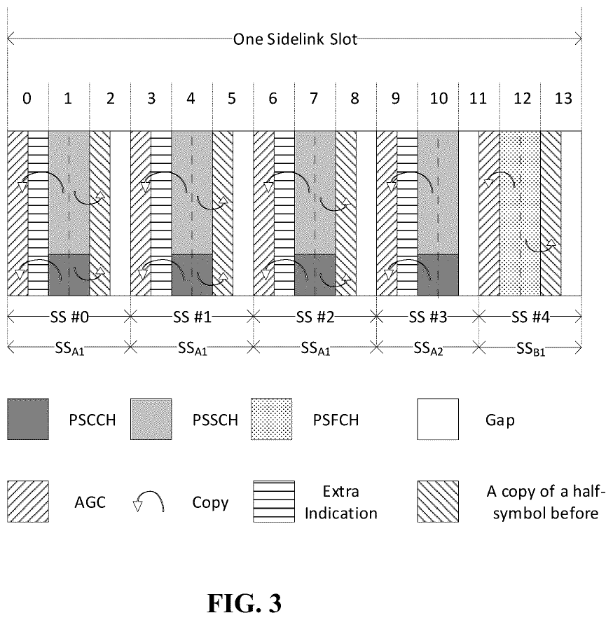

FIG. 3 illustrates an exemplary sidelink sub-slot pattern according to some embodiments of the present application. In the embodiments of FIG. 3, one sidelink slot includes 14 OFDM symbols in total, i.e., OFDM symbol #0 to OFDM symbol #13.

According to the embodiments of FIG. 3, the sidelink slot as illustrated by FIG. 3 includes five sidelink sub-slots in total, i.e., SS #0, SS #1, SS #2, SS #3, and SS #4. All of SS #0, SS #1, and SS #2 belong to sub-slot type SS_{A1}, which comprises one CS₁, one FS₁ and one CS₂. SS #3 belongs to sub-slot type SS_{A2}, which comprises one CS₁, one FS₁ and one HS₂. SS #4 belongs to sub-slot type SS_{B1}, which comprises one HS₁, one FS₃ and one CS₂.

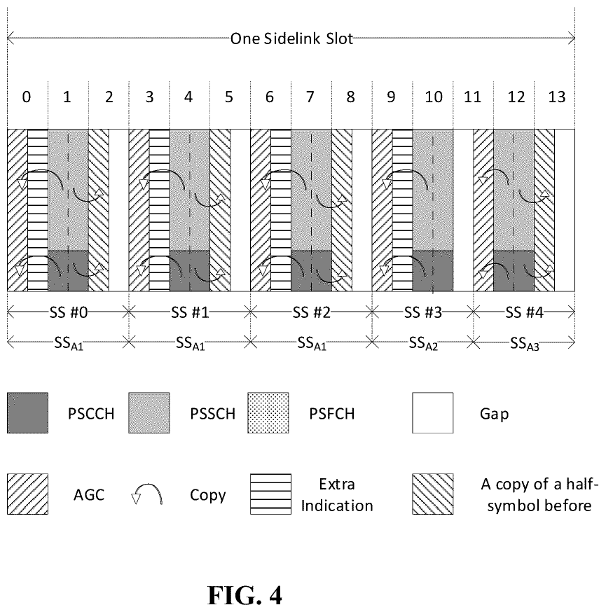

FIG. 4 illustrates another exemplary sidelink sub-slot pattern according to some other embodiments of the present application. In the embodiments of FIG. 4, one sidelink slot includes 14 OFDM symbols in total, i.e., OFDM symbol #0 to OFDM symbol #13.

According to the embodiments of FIG. 4, the sidelink slot as illustrated by FIG. 4 includes five sidelink sub-slots in total, i.e., SS #0, SS #1, SS #2, SS #3, and SS #4. All of SS #0, SS #1, and SS #2, and SS #3 are the same as SS #0, SS #1, and SS #2, and SS #3 in FIG. 3, respectively. The difference is that in the embodiments of FIG. 4, SS #4 belongs to sub-slot type SS_{A3}, which comprises one HS₁, one FS₁, and one CS₂.

The sidelink sub-slot patterns (also referred to as sub-slot patterns) in FIGS. 3 and 4 are only for illustrative purpose, it is contemplated that the sub-slot patterns may be other patterns according to some other embodiments of the present application, and that one slot may include more than two sub-slots.

Currently, since only a slot-based transmission is supported for a sidelink, resource allocation and indication methods are needed to support a sub-slot level sidelink transmission. Therefore, an issue of “how to support sub-slot level sidelink transmission in coexistence with an existing slot-based sidelink system” needs to be solved. In other words, when different time intervals (e.g., slot level and sub-slot level) exist in the same resource pool, how to support multiplexing of resource allocation results determined in different time intervals needs to be solved.

Given the above, embodiments of the present application provide improved solutions for resource allocation in SL communication, which provides several methods for supporting multiplexing of resource allocation results determined in different time intervals, thereby achieving the coexistence of sub-slot level sidelink transmission and slot level sidelink transmission. More details on embodiments of the present application will be illustrated in the following text in combination with the appended drawings.

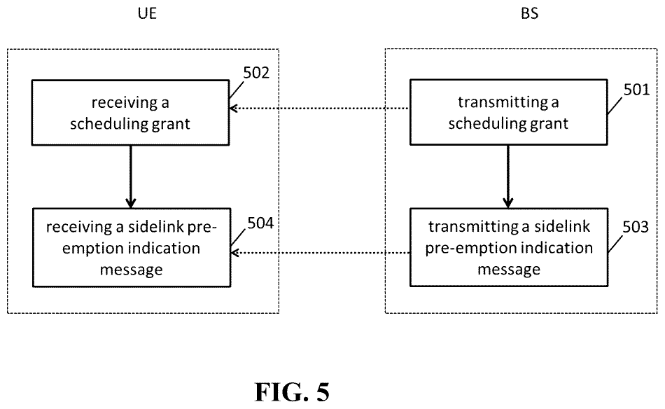

FIG. 5 illustrates an exemplary flowchart of a method for resource allocation according to some embodiments of the present application. Although the method is illustrated in a system level by a UE (e.g., UE 101a or UE 101b in FIG. 1) and a BS (e.g., BS 102), persons skilled in the art can understand that the method implemented in the UE and the method implemented in the BS can be separately implemented and incorporated in other apparatus with the like functions.

Embodiments of FIG. 5 provide resource allocation methods for resource allocation Mode 1. Specifically, in case of resource allocation Mode 1, a sidelink transmission (e.g., a PSSCH transmission and/or a PSCCH transmission) can only be carried out by a UE if the UE has been provided with a valid scheduling grant that indicates the exact set of resources used for the sidelink transmission. Assuming that both slot-level resource allocation and sub-slot level resource allocation are configured in one resource pool (RP), dynamic grant implies that the scheduling grant can be made in different time intervals, i.e., either slot or sub-slot.

For example, a UE (e.g., UE 101a) may transmit a first scheduling request to a BS (e.g., BS 102) to request resources for a sidelink communication.

After receiving the first scheduling request, in step 501, the BS may transmit a scheduling grant associated with a resource pool to the UE. The scheduling grant may indicate a first set of resources in the resource pool for a SL transmission. Consequently, in step 502, the UE may receive the scheduling grant indicating the first set of resources for the SL transmission from the BS.

In some embodiments of the present application, the first set of resources may include one or more slots in the time domain and one or more sub-channels in the frequency domain. In other words, the first set of resources may be represented by a pair of slot(s) and sub-channel(s). In some other embodiments of the present application, the first set of resources may include one or more sub-slots in the time domain and one or more sub-channels in the frequency domain. In other words, the first set of resources may be represented by a pair of sub-slot(s) and sub-channel(s). For the sake of simplicity, embodiments of the present application are only described with the example that the first set of resources is represented by slot(s) in the time domain.

In some cases, another UE (e.g., UE 101b) may also transmit a second scheduling request to the BS to request resources for another sidelink communication, which may be a latency-critical traffic transmission in the same RP. In some embodiments of the present application, another UE has a higher priority of sidelink transmission than the UE.

If there are sufficient frequency resources in the RP, the BS may transmit a scheduling grant indicating resources not overlapping with the first set of resources to another UE. However, in the case of a high load in the RP, the BS has to schedule resources for transmission from another UE by using partial or all resources originally scheduled to the UE. In such cases, the BS may transmit a scheduling grant indicating resources which partially overlaps with or fully overlaps with the first set of resources to another UE. In other words, the transmission from another UE is preempting the resources for transmission from the UE.

In such cases, in step 503, the BS may transmit a sidelink pre-emption indication message to the UE to indicate partial of the first set of resources or all of the first set of resources are pre-empted. Consequently, in step 504, the UE may receive the sidelink pre-emption indication message from the BS.

In an embodiment of the present application, the sidelink pre-emption indication message is transmitted or received in at least one of the following signalings:
a UE-specific DCI (e.g., DCI format 3_0 as specified in 3GPP standard documents) for the UE;
a group-common DCI (e.g. DCI format 2_1 as specified in 3GPP standard documents) for a group of UEs including the UE. In some embodiments of the present application, the group of UEs including the UE does not include another UE. That is to say, the UE and another UE belong to different UE group such that the SL preemption indication message is transparent to another UE.
a MAC CE; or
a RRC signaling.

In some embodiments of the present application, the sidelink pre-emption indication message may include a SL-PI indicating that at least one second set of resources of the first set of resources is pre-empted.

In such embodiments, the first set of resources may be divided into one or more second sets of resources. In other words, the first set of resources may include one or more second sets of resources. Each second set of resource may include a number of consecutive sub-slot(s) in the time domain and a number of consecutive sub-channel(s) in the frequency domain. In other words, each second set of resources is represented by a pair of sub-slot(s) and sub-channel(s).

In an embodiment of the present application, a sub-slot pattern of the sub-slot(s) associated with a second set of resources is indicated by a sub-slot pattern index. Generally, a sub-slot pattern may refer to a format of a slot in units of sub-slots, which includes the number of sub-slots within a slot, the number of symbols and the number of half-symbols within each sub-slot, and the content included in each symbol and/or half-symbol. For example, the sub-slot pattern index may indicate that the sub-slot pattern is that shown in FIG. 3 or shown in FIG. 4.

The sub-slot pattern index may be included in a resource pool configuration for the resource pool. The resource pool configuration may be configured to the UE by the BS (e.g., via an RRC signaling, MAC CE, or DCI) or pre-configured for the UE.

That is, based on the sub-slot pattern index, both the BS and UE know the format of sub-slots within a slot. The time resources (i.e. one or more sub-slots) of each second set of resource may be further determined based a parameter (e.g., NumOfSubSlotInOneResourceSet), which indicates a number of consecutive sub-slots included in a second set of resources. A default value of the parameter NumOfSubSlotInOneResourceSet may be set to one. In an embodiment of the present application, the parameter is transmitted in DCI carrying the sidelink pre-emption indication message or in a resource pool configuration for the resource pool. Consequently, the UE may receive the parameter in the DCI carrying the sidelink pre-emption indication message or in the resource pool configuration for the resource pool. Therefore, the BS and the UE may determine the time resources (i.e., including one or more sub-slots) of each second set of resource based on the sub-slot pattern index and the parameter of NumOfSubSlotInOneResourceSet.

The frequency resources (i.e., one or more sub-channels) of each second set of resource may be determined based on a parameter (e.g., NumOfSChInOneResourceSet) transmitted by the BS. In an embodiment of the present application, the parameter is transmitted in DCI carrying the sidelink pre-emption indication message or in a resource pool configuration for the resource pool. Consequently, the UE may receive the parameter in the DCI carrying the sidelink pre-emption indication message or in the resource pool configuration for the resource pool. The parameter may be defined as indicating a number of consecutive sub-channels included in a second set of resources. Alternatively, the parameter may be defined as indicating a number of groups, into which the first set of resources in the frequency domain are divided. For the sake of simplicity, embodiments of the present application are only described with the former definition of NumOfSChInOneResourceSet.

For example, it is assumed that the first set of resources includes sub-channels #2 to #5 in the RP, the value of NumOfSubSlotInOneResourceSet is the default value “1” and the value of NumOfSChInOneResourceSet is 4 (which means that each second set of resources include 4 consecutive sub-channels. In other words, all the sub-channels #2 to #5 are divided into one group of sub-channels), then each second set of resource may include sub-channels #2 to #5 in the frequency domain. In another embodiment, it is assumed that the first set of resources includes sub-channels #2 to #5 in the RP, the value of NumOfSubSlotInOneResourceSet is the default value “1” and the parameter NumOfSChInOneResourceSet is 2 (which means that each second set of resources include 2 consecutive sub-channels. In other words, all the sub-channels #2 to #5 are divided into two groups of sub-channels), then each second set of resources may include two sub-channels (e.g., sub-channels #2 to #3 or sub-channels #4 to #5 in the frequency domain).

In some embodiments of the present application, the SL-PI is a bitmap. The bits included in the bitmap are associated with the one or more second sets of resources included in the first set of resources by one-to-one mapping. Therefore, the number of bits included in the bitmap may equal to the number of second sets of resources included in the first set of resources. Each bit of the bitmap may indicate whether a corresponding second set of resources of the one or more second sets of resources included in the first set of resources is pre-empted.

In some other embodiments of the present application, the SL-PI is at least one indication indicating the pre-empted at least one second set of resources. In such embodiments, each indication may indicate a corresponding second set of resources of the at least one second set of resources. For example, each indication may be a two-tuple parameter (T, F), wherein T indicates the index of a sub-slot and F indicates the position in the frequency domain which is in terms of sub-channels and calculated from the lowest position of all sub-channels included in the first set of resources allocated to the UE. In another example, each indication may be an index of a corresponding second set of resources of the pre-empted at least one second set of resources.

In some embodiments of the present application, the monitoring periodicity of the sidelink pre-emption indication message may be configured (e.g., via an RRC signaling, MAC CE, or DCI) by the BS to the first UE or may be pre-configured in the UE, such as every N slots (or sub-slots), wherein N can be an integer.

Then, after receiving the SL-PI, the UE may determine which part of the first set of resources is pre-empted. The UE may perform some corresponding operations based on the sidelink pre-emption indication message.

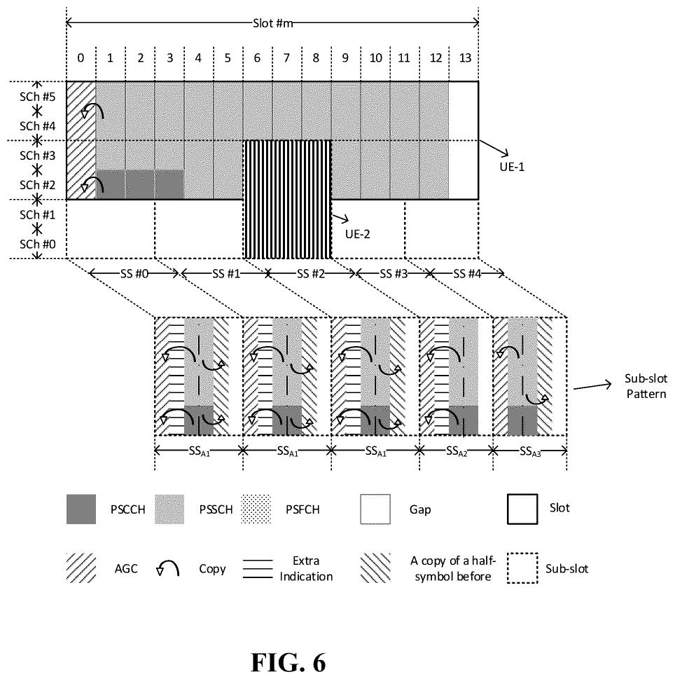

FIG. 6 illustrates an exemplary resource allocation according to some embodiments of the present application.

Referring to FIG. 6, the BS may transmit scheduling grant #1 to a UE (e.g., UE-1), the scheduling grant #1 may indicate a first set of resources. The first set of resources may include one slot (e.g., a slot #m) in the time domain and four consecutive sub-channels from SCh #2 to SCh #5 in the frequency domain. In the embodiments of FIG. 6, one slot may include 14 OFDM symbols in total, i.e., OFDM symbol #0 to OFDM symbol #13. Although a specific number of OFDM symbols in one sidelink slot are depicted in FIG. 6, it is contemplated that any number of OFDM symbols as specified in 3GPP standards may be included in one sidelink slot.

The BS may transmit scheduling grant #2 to another UE (e.g., UE-2), the scheduling grant #2 may indicate a set of resources. The set of resources may include OFDM symbol #6 to OFDM symbol #8 in slot #m and four sub-channels (e.g., SCh #0 to SCh #3) in the frequency domain.

The first set of resources may be divided into one or more second set of resources. Each second set of resources may be represented by a pair of sub-slot(s) and sub-channel(s).

The sub-slot pattern of the sub-slot(s) may be indicated by a sub-slot pattern index. In the embodiments of FIG. 6, the sub-slot pattern index indicates a sub-slot pattern as shown in FIG. 4. Then, based on the sub-slot pattern index, the BS may determine that the slot includes five sidelink sub-slots in total, i.e., SS #0 (which includes OFDM symbol #0 to OFDM symbol #2), SS #1 (which includes OFDM symbol #3 to OFDM symbol #5), SS #2 (which includes OFDM symbol #6 to OFDM symbol #8), SS #3 (which includes OFDM symbol #9 to OFDM symbol #10 and the first half OFDM symbol #11), and SS #4 (which includes the last half OFDM symbol #11 and OFDM symbol #12 to OFDM symbol #13). All of SS #0, SS #1, and SS #2 belong to sub-slot type SS_{A1}. SS #3 belongs to sub-slot type SS_{A2}. SS #4 belongs to sub-slot type SS_{A3}. In the embodiments of FIG. 6, the value of NumOfSubSlotInOneResourceSet is a default value “1”. That is, each second set of resources may include one sub-slot in the time domain.

The frequency resources of each second set of resource may be determined based on a parameter (e.g., NumOfSChInOneResourceSet). In an example, it is assumed that the parameter NumOfSChInOneResourceSet is 4, then each second set of resource may include sub-channels #2 to #5 in the frequency domain. In another embodiment, it is assumed that the parameter NumOfSChInOneResourceSet is 2, then each second set of resource may include two sub-channels (e.g., sub-channels #2 to #3 or sub-channels #4 to #5 in the frequency domain).

Consequently, in some embodiments, the first set of resources may include five second sets of resources (e.g., resource set (RS) #0, RS #1, RS #2, RS #3, and RS #4) in the case that NumOfSubSlotInOneResourceSet is equal to 1 and NumOfSChInOneResourceSet is equal to 4, wherein RS #0 is represented by SS #0 and sub-channels #2 to #5, RS #1 is represented by SS #1 and sub-channels #2 to #5, RS #2 is represented by SS #2 and sub-channels #2 to #5, RS #3 is represented by SS #3 and sub-channels #2 to #5, and RS #4 is represented by SS #4 and sub-channels #2 to #5.

In some other embodiments, the first set of resources may include ten second sets of resources (e.g., RS #0, RS #1, RS #2, RS #3, RS #4, RS #5, RS #6, RS #7, RS #8, RS #9) in the case that NumOfSubSlotInOneResourceSet is equal to 1 and NumOfSChInOneResourceSet is equal to 2, wherein RS #0 is represented by SS #0 and sub-channels #2 to #3, RS #1 is represented by SS #1 and sub-channels #2 to #3, RS #2 is represented by SS #2 and sub-channels #2 to #3, RS #3 is represented by SS #3 and sub-channels #2 to #3, RS #4 is represented by SS #4 and sub-channels #2 to #3. RS #5 is represented by SS #0 and sub-channels #4 to #5, RS #6 is represented by SS #1 and sub-channels #4 to #5, RS #7 is represented by SS #2 and sub-channels #4 to #5, RS #8 is represented by SS #3 and sub-channels #4 to #5, RS #9 is represented by SS #4 and sub-channels #4 to #5.

The BS may determine that the set of resources allocated to UE2 partially overlaps with the first set of resources, i.e., SS #2 and SCh #2 to SCh #3. Then, the BS may transmit SL-PI to indicate the pre-emption.

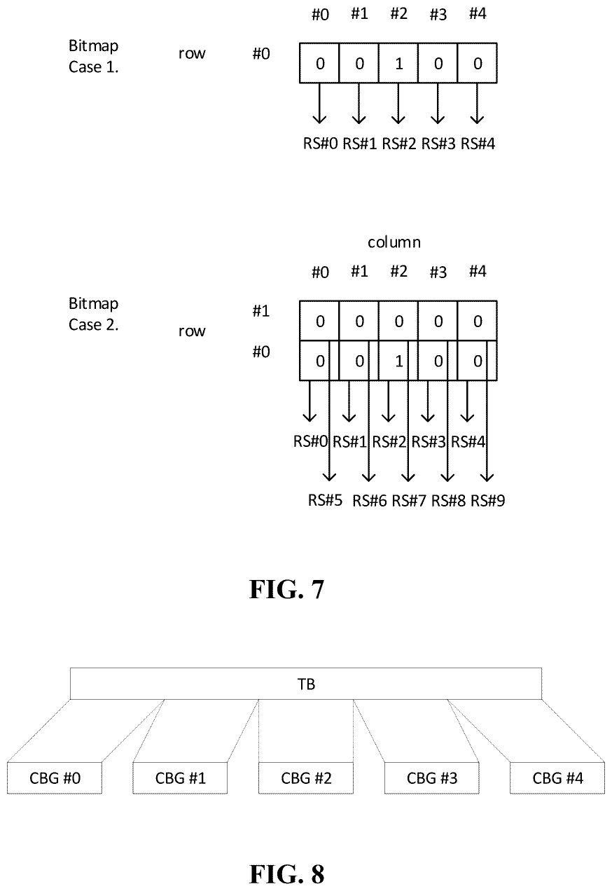

In some embodiments, the SL-PI is a bitmap. For example, FIG. 7 illustrates examples of SL-PI according to some embodiments of the present application.

Referring to FIG. 7, the number of bits included in the bitmap is equal to the number of second sets of resources. A bit value “0” indicates that the corresponding second set of resources is not pre-empted, and a bit value “1” indicates that the corresponding second set of resources is not pre-empted.

In case 1, the first set of resources may include five second sets of resources (e.g., RS #0, RS #1, RS #2, RS #3, and RS #4) as stated above, then the bitmap includes five bits, each bit indicates whether a corresponding RS is pre-empted. For example, a bit value “0” indicates that the corresponding second set of resources is not pre-empted, and a bit value “1” indicates that the corresponding second set of resources is entirely or partially pre-empted. In case 1, the set of resources allocated to UE2 partially overlaps with RS #2, thus the bitmap is “00100.”

In case 2, the first set of resources may include ten second sets of resources (e.g., RS #0, RS #1, RS #2, RS #3, RS #4, RS #5, RS #6, RS #7, RS #8, RS #9) as stated above, then the bitmap includes ten bits, each bit in the row #0 indicates whether RS #0, RS #1, RS #2, RS #3, or RS #4 is pre-empted respectively, and each bit in the row #1 indicates whether RS #5, RS #6, RS #7, RS #8, or RS #9 is pre-empted respectively. Since the set of resources allocated to UE2 partially overlaps with RS #2, the bitmap is “₀₀₁₀₀⁰⁰⁰⁰⁰”.

The UE use the same sub-slot pattern, NumOfSubSlotInOneResourceSet and the NumOfSChInOneResourceSet as the BS to divide the first set of resources into one or more second sets of resources. Consequently, after receiving the bitmap, the UE may determine which part of the first set of resources is pre-empted.

In some other embodiments, the SL-PI is at least one indication. In the embodiments of FIG. 7, the SL-PI is one indication.

Specifically, in the case that the first set of resources includes five second sets of resources (e.g., RS #0, RS #1, RS #2, RS #3, and RS #4) as stated above, in an example, the one indication is (2, 0), wherein the value of 2 indicates SS #2 and the value of 0 indicates all the sub-channels from #2 to #5 allocated to UE-1 in the frequency domain since the frequency domain granularity is indicated by NumOfSChInOneResourceSet as 4. In another example, the one indication is 2, wherein the value 2 is the index of RS #2.

In the case that the first set of resources may include ten second sets of resources (e.g., RS #0, RS #1, RS #2, RS #3, RS #4, RS #5, RS #6, RS #7, RS #8, RS #9) as stated above, in an example, the one indication is (2, 0), where the value of 2 indicates SS #2 while the value of 0 indicates the first group of sub-channels (e.g., sub-channels from #2 to #3) allocated to UE-1 in the frequency domain since the frequency domain granularity is indicated by NumOfSChInOneResourceSet as 2. In another example, the one indication is 2, wherein the value 2 is the index of RS #2.

The UE use the same sub-slot pattern, NumOfSubSlotInOneResourceSet and the NumOfSChInOneResourceSet as the BS to divide the first set of resources into one or more second sets of resources. Consequently, after receiving the indication, the UE may determine which part of the first set of resources is pre-empted.

As specified in 3GPP standard documents, HARQ retransmission is used when UE reports negative acknowledgement (NACK). The retransmission of a whole transport block (TB) may result in lower spectrum efficiency and higher latency. In order to solve the above problem, a finer granularity of retransmission, referred to as code-block groups (CBG) based retransmission, was introduced in NR, wherein a TB is segmented into multiple CBGs. For example, FIG. 8 illustrates exemplary TB segmentation according to some embodiments of the present application, wherein a TB is segmented into five CBGs, labeled as CBG #0, CBG #1. CBG #2, CBG #3, and CBG #4. In such cases, only impacted CBGs other than the whole TB are needed to be retransmitted when erroneous reception occurs. CBG can also be used in handling preemption to achieve high efficiency.

Considering the resources allocation in sub-slot level, according to some embodiments of the present application, when doing TB segmentation and resource mapping for the segmented CBGs, the UE may align the boundary of CBG with sub-slot boundary. In other words, when receiving the first set of resources, the UE may divide the first set of resources into one or more second sets of resources based on the sub-slot pattern index. Each second set of resources may include one or more sub-slots. The UE may perform the TB segmentation and resource mapping for the segmented CBGs such that each sub-slot is used to transmit integer number of CBGs of a TB from the UE. That is, each sub-slot can carry one or more CBGs. In other words, it is not permitted for a transmission of one CBG to be cross the boundary of sub-slots.

According to some other embodiments, a CBG-based transmission as stated above may be enabled or disabled by a CBG transmission indication. In such embodiments, the BS may transmit a CBG transmission indication which indicates to enable or disable a CBG-based transmission for the resource pool to the UE such that the UE may receive the CBG transmission indication. In some embodiments of the present application, the CBG transmission indication is transmitted or received in DCI carrying the sidelink pre-emption indication message or in a resource pool configuration for the resource pool.

In the case that the CBG transmission indication indicates to enable the CBG-based transmission for the resource pool, after receiving the CBG transmission indication and the first set of resources, the UE may divide the first set of resources into one or more second sets of resources based on the sub-slot pattern index, each second set of resources may include one or more sub-slots. The UE may perform the TB segmentation and resource mapping for the segmented CBGs such that each sub-slot is used to transmit integer number of CBGs of a TB from the UE.

Specifically, since the UE knows about the sub-slot pattern configured for the RP, the UE knows about how many symbols and/or half-symbols within each sub-slot of the pattern. Considering the size of a CBG, the UE may assign the segmented CBGs to the sub-slots by the following two manners.

First, if all segmented CBGs of a TB are specified to be with a uniform size, UE may fix the size for each CBG and assign different number of CBGs to each sub-slot by taking into account of the time duration of each sub-slot and a given coding rate constraint.

Second, if all segmented CBGs of a TB are not specified to be with a uniform size, UE may assign one or more CBGs with different sizes to each sub-slot by only considering the time duration of each sub-slot and given coding rate constraint, which is more flexible.

In some embodiments of the present application, the segmentation of TB into CBGs following a sub-slot pattern can either be specified or be left up to UE implementation of the UE.

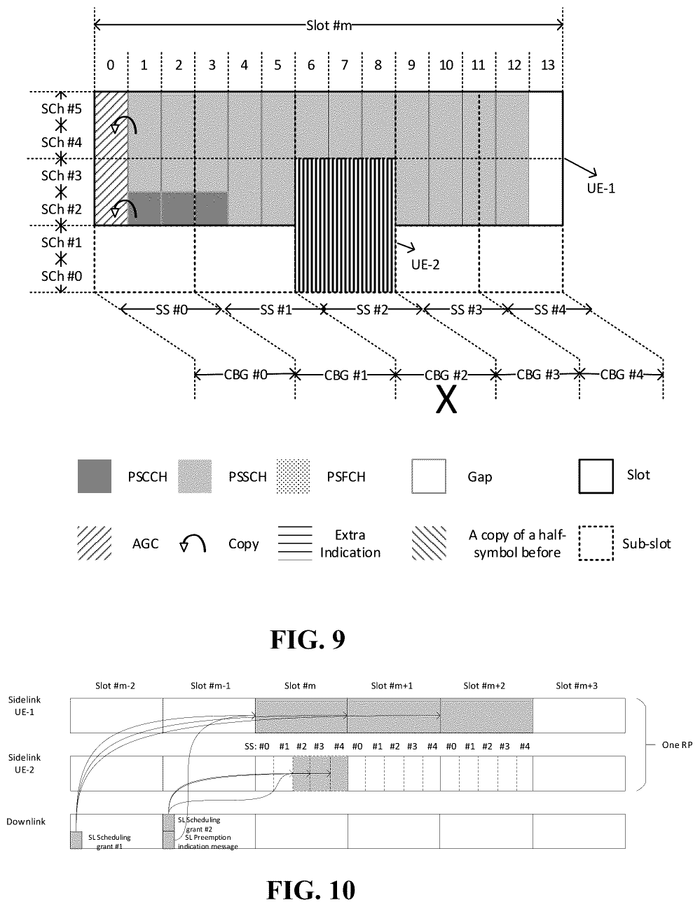

FIG. 9 illustrates an exemplary CBG-based transmission according to some embodiments of the present application.

Referring to FIG. 9, the BS may transmit scheduling grant #1 to the UE (e.g., UE-1), the scheduling grant #1 may indicate a first set of resources. The first set of resources may include one slot (e.g., a slot #m) in the time domain and four consecutive sub-channels from SCh #2 to SCh #5 in the frequency domain. In the embodiments of FIG. 6, one sidelink slot may include 14 OFDM symbols in total, i.e., OFDM symbol #0 to OFDM symbol #13.

The BS may transmit scheduling grant #2 to another UE (e.g., UE-2), the scheduling grant #2 may indicate a set of resources. The set of resources may include OFDM symbol #6 to OFDM symbol #8 in slot #m and four sub-channels (e.g., SCh #0 to SCh #3) in the frequency domain.

In the embodiments of FIG. 9, the UE-1 may use a CBG-based transmission. In such embodiments, the UE-1 may divide the first set of resources into one or more parts (in units of sub-slots) in the time domain.

Based on the sub-slot pattern index, the UE-1 may determine sub-slot(s) included in a slot. In the embodiments of FIG. 9, the sub-slot pattern index indicates a sub-slot pattern as shown in FIG. 4. Then, based on the sub-slot pattern index, the UE-1 may determine that the slot includes five sidelink sub-slots in total, i.e., SS #0 (which includes OFDM symbol #0 to OFDM symbol #2), SS #1 (which includes OFDM symbol #3 to OFDM symbol #5), SS #2 (which includes OFDM symbol #6 to OFDM symbol #8), SS #3 (which includes OFDM symbol #9 to OFDM symbol #10 and the first half OFDM symbol #11), and SS #4 (which includes the last half OFDM symbol #11 and OFDM symbol #12 to OFDM symbol #13).

The UE-1 may segment a TB into five CBGs as shown in FIG. 8 and map these five CBGs to the five sub-slots, respectively, wherein CBG #0 is mapped to the SS #0, CBG #1 is mapped to the SS #1, CBG #2 is mapped to the SS #2, CBG #3 is mapped to the SS #3, and CBG #4 is mapped to the SS #4.

The benefit of this mapping is to decrease the number of CBGs impacted by preemption from sub-slot level transmission. Specifically, in the embodiments of FIG. 9, SS #2 is pre-empted by UE-2 and thus the CBG #2 is not transmitted successfully, then the UE-1 only has to retransmit the impacted CBG #2.

According to some embodiments of the present application, in addition to the SL-PI, the sidelink pre-emption indication message may further include at least one of followings: an SL cancellation indication; a permitted power level for an intended SL transmission of the UE; or an SL puncture indication. Specifically, which indication are included in the sidelink pre-emption indication message may be based on whether the sidelink pre-emption indication message can be received before the transmission on the first set of resources and whether the UE uses a CBG-based transmission.

FIG. 10 illustrates an exemplary transmission of sidelink pre-emption indication message according to some embodiments of the present application, wherein the sidelink pre-emption indication message is received before the transmission on the first set of resources and the UE does not use a CBG-based transmission.

Referring to FIG. 10, in response to a scheduling request from the UE (e.g., UE-1), the BS may transmit a scheduling grant #1 in the downlink slot #m−2 to the UE-1, the scheduling grant may indicate resources spanning slot #m, #m+1 and #m+2 for UE-1 to do sidelink transmission and retransmission of a TB. In the embodiments of FIG. 10, the sub-slot pattern within each slot may be the sub-slot pattern as shown in FIG. 4, and each slot may include five second sets of resources, i.e., SS #0, SS #1, SS #2, SS #3, and SS #4 in the time domain and all the sub-channels allocated to UE-1 in the frequency domain.

In response to a scheduling request from another UE (e.g., UE-2), the BS may transmit a scheduling grant #2 in the downlink slot #m−1 to the UE-2, the scheduling grant #2 may indicate the resources allocated to the UE-2, such as SS #2, SS #3 and SS #4 within slot #m. Due to latency budget of a sidelink transmission from UE-2 and a high load in the selected RP, the resources indicated in the scheduling grant #2 partially overlap with the resources indicated in the scheduling grant #1. In some embodiments of the present application, the SL scheduling grant #2 may also indicate a power boosting operation for UE-2 to increase success probability of SL transmission.

In the downlink slot #m−1, the BS may also transmit a sidelink pre-emption indication message to UE-1 to indicate at least one second set of resources (e.g., SS #2. SS #3 and SS #4) is pre-empted. The sidelink pre-emption indication message may include an SL-PI as illustrated in the above embodiments.

In addition to the SL-PI, the sidelink pre-emption indication message may also include at least one of: an SL cancellation indication or a permitted power level for an intended SL transmission of UE-1. The SL cancellation indication may indicate the UE-1 to cancel its intended SL transmission (e.g., the whole TB) in at least one slot including the pre-empted at least one second set of resources (e.g., slot #m including SS #2, SS #3 and SS #4). The permitted power level for an intended SL transmission of UE-1 may put a constraint on power for the intended SL transmission from UE-1 in slot #m.

In an embodiment of the present application, the SL cancellation indication and the permitted power level may be represented by a two-bit indication, wherein one value of the two-bit indication is used as the SL cancellation indication to indicate cancelling intended SL transmission while remaining three values indicate three different permitted power levels. For example, the value “00” is the SL cancellation indication, and the values “01,” “02,” and “03” indicate three different permitted power levels for the intended SL transmission, respectively.

Then, after receiving the scheduling grant #2 in slot #m−1, UE-2 may perform the sidelink transmission on the SS #2, SS #3 and SS #4 in slot #m.

After receiving the scheduling grant #1 in slot #m−2 and the sidelink pre-emption indication message in slot #m−1, the UE-1 may perform the sidelink transmission based on the sidelink pre-emption indication message.

For example, in response to receiving the SL cancellation indication, the UE-1 may cancel an intended SL transmission in at least one slot (e.g., slot #m) including the at least one second set of resources (e.g., SS #2, SS #3 and SS #4). Specifically, since UE-1 does not use a CBG-based transmission, slot #m may include a TB. Accordingly, canceling the intended SL transmission in slot #m may refer to canceling the whole TB in slot #m.

In another example, in response to receiving the permitted power level, the UE-1 may transmit an intended SL transmission in at least one slot (e.g., slot #m) including the at least one second set of resources (e.g., SS #2, SS #3 and SS #4) based on the permitted power level. For example, the transmitting power of the intended SL transmission cannot exceed the permitted power level. Specifically, since UE-1 does not use a CBG-based transmission, slot #m may include a TB. Accordingly, the transmitting power of the TB slot #m cannot exceed the permitted power level.

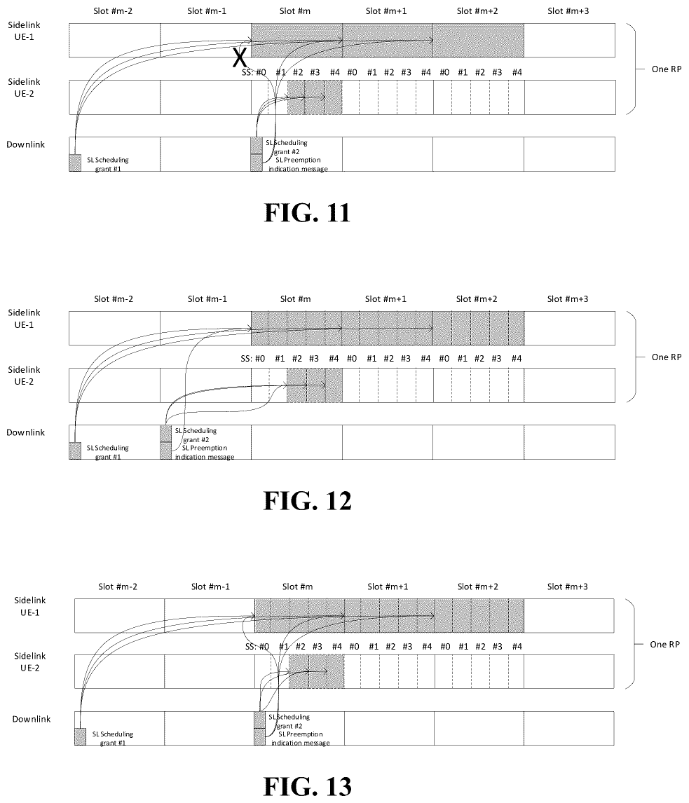

FIG. 11 illustrates another exemplary transmission of sidelink pre-emption indication message according to some other embodiments of the present application, wherein the sidelink pre-emption indication message is not received before the transmission on the first set of resources and the UE does not use a CBG-based transmission.

Referring to FIG. 11, in response to a scheduling request from the UE (e.g., UE-1), the BS may transmit a scheduling grant #1 in the downlink slot #m−2 to the UE-1, the scheduling grant may indicate resources spanning slot #m, #m+1 and #m+2 for UE-1 to do sidelink transmission and re-transmission of a TB. In the embodiments of FIG. 11, the sub-slot pattern within each slot may be the sub-slot pattern as shown in FIG. 4, and each slot may include five second sets of resources, i.e., SS #0, SS #1, SS #2, SS #3, and SS #4 in the time domain and all the sub-channels allocated to UE-1 in the frequency domain.

In response to a scheduling request from another UE (e.g., UE-2), the BS may transmit a scheduling grant #2 in the slot #m to the UE-2, the scheduling grant #2 may indicate the resources allocated to the UE-2, such as SS #2, SS #3 and SS #4 within slot #m. Due to latency budget of a sidelink transmission from UE-2 and a high load in the selected RP, the resources indicated in the scheduling grant #2 partially overlap with the resources indicated in the scheduling grant #1. In some embodiments of the present application, the SL scheduling grant #2 may also indicate a power boosting operation for UE-2 to increase success probability of the SL transmission. The UE-2 may receive the scheduling grant #2 before SS #2 in slot #m.

In the slot #m, the BS may also transmit a sidelink pre-emption indication message to UE-1 to indicate at least one second set of resources (e.g., SS #2, SS #3 and SS #4) is pre-empted. The sidelink pre-emption indication message may include an SL-PI as illustrated in the above embodiments. In such embodiments, the UE-1 cannot receive the sidelink pre-emption indication message before the transmission in slot #m, but may receive the sidelink pre-emption indication message during slot #m.

Then, after receiving the scheduling grant #2 before SS #2 in slot #m, UE-2 may perform the sidelink transmission on the SS #2, SS #3 and SS #4 in slot #m.

After receiving the scheduling grant #1 in slot #m−2 and the sidelink pre-emption indication message in slot #m, since the UE-1 cannot receive the sidelink pre-emption indication message at the beginning of transmission on slot #m, the UE-1 may still perform an SL transmission in slot #m. In the embodiments of FIG. 11, the SL transmission in slot #m may be a TB. However, such an SL transmission from UE-1 may not be transmitted successfully because of interference caused by the sidelink transmission from the UE-2.

In such embodiments, the benefit of the SL-PI is that it can facilitate the UE to do retransmission decision on succeeding retransmission resources. For example, the UE may determine that the SL transmission in slot #m will be retransmitted in the Slot #m+1 and/or Slot #m+2 based on the SL-PI.

FIG. 12 illustrates yet another exemplary transmission of sidelink pre-emption indication message according to some embodiments of the present application, wherein the sidelink pre-emption indication message is received before the transmission on the first set of resources and the UE uses a CBG-based transmission.

Referring to FIG. 12, in response to a scheduling request from the UE (e.g., UE-1), the BS may transmit a scheduling grant #1 in the slot #m−2 to the UE-1, the scheduling grant may indicate resources spanning slot #m, #m+1 and #m+2 for UE-1 to do sidelink transmission and re-transmission of a TB. In the embodiments of FIG. 12, the sub-slot pattern within each slot may be the sub-slot pattern as shown in FIG. 4, and each slot may include five second sets of resources, i.e., SS #0, SS #1, SS #2, SS #3, and SS #4 in the time domain and all the sub-channels allocated to UE-1 in the frequency domain.

In response to a scheduling request from another UE (e.g., UE-2), the BS may transmit a scheduling grant #2 in the slot #m−1 to the UE-2, the scheduling grant #2 may indicate the resources allocated to the UE-2, such as SS #2, SS #3 and SS #4 within slot #m. Due to latency budget of a sidelink transmission from UE-2 and a high load in the selected RP, the resources indicated in the scheduling grant #2 partially overlap with the resources indicated in the scheduling grant #1. In some embodiments of the present application, the SL scheduling grant #2 may also indicate a power boosting operation for UE-2 to increase success probability of SL transmission.

In the slot #m−1, the BS may also transmit a sidelink pre-emption indication message to UE-1 to indicate at least one second set of resources (e.g., SS #2, SS #3 and SS #4) is pre-empted. The sidelink pre-emption indication message may include an SL-PI as illustrated in the above embodiments.

In addition to the SL-PI, the sidelink pre-emption indication message may also include at least one of: an SL cancellation indication or a permitted power level for an intended SL transmission of UE-1. The SL cancellation indication may indicate the UE-1 to cancel its intended SL transmission (e.g., one or more CBGs) in the pre-empted at least one second set of resources (e.g., SS #2, SS #3 and SS #4). The permitted power level for an intended SL transmission of UE-1 may put a constraint on power for the intended SL transmission from UE-1 in SS #2, SS #3 and SS #4. Similar as the embodiments in FIG. 10, the SL cancellation indication and the permitted power level may also be represented by a two-bit indication.

Then, after receiving the scheduling grant #2 in slot #m−1, UE-2 may perform the sidelink transmission on the SS #2, SS #3 and SS #4 in slot #m.

After receiving the scheduling grant #1 in slot #m−2 and the sidelink pre-emption indication message in slot #m−1, the UE-1 may perform the sidelink transmission based on the sidelink pre-emption indication message.

For example, in response to receiving the SL cancellation indication, the UE-1 may just cancel an intended SL transmission in the at least one second set of resources (e.g., SS #2, SS #3 and SS #4). Since the UE-1 uses a CBG-based transmission (in other words, each of SS #2, SS #3 and SS #4 includes one or more CBGs), canceling intended SL transmission may refer to canceling all the CBGs in SS #2, SS #3 and SS #4.

In another example, in response to receiving the permitted power level, the UE-1 may transmit an intended SL transmission in the at least one second set of resources (e.g., SS #2, SS #3 and SS #4) based on the permitted power level. Since each of SS #2, SS #3 and SS #4 includes one or more CBGs, transmitting an intended SL transmission based on the permitted power level may refer to that the transmitting power of all the CBGs in SS #2, SS #3 and SS #4 does not exceed the permitted power level.

FIG. 13 illustrates yet another exemplary transmission of sidelink pre-emption indication message according to some other embodiments of the present application, wherein the sidelink pre-emption indication message is not received before the transmission on the first set of resources and the UE uses a CBG-based transmission.

Referring to FIG. 13, in response to a scheduling request from the UE (e.g., UE-1), the BS may transmit a scheduling grant #1 in the slot #m−2 to the UE-1, the scheduling grant may indicate resources spanning slot #m, #m+1 and #m+2 for UE-1 to do sidelink transmission and re-transmission of a TB. In the embodiments of FIG. 13, the sub-slot pattern within each slot may be the sub-slot pattern as shown in FIG. 3, and each slot may include five second sets of resources, i.e., SS #0, SS #1, SS #2, SS #3, and SS #4 in the time domain and all the sub-channels allocated to UE-1 in the frequency domain.

In response to a scheduling request from another UE (e.g., UE-2), the BS may transmit a scheduling grant #2 in the slot #m to the UE-2, the scheduling grant #2 may indicate the resources allocated to the UE-2, such as SS #2, SS #3 and SS #4 within slot #m. Due to latency budget of a sidelink transmission from UE-2 and a high load in the selected RP, the resources indicated in the scheduling grant #2 partially overlap with the resources indicated in the scheduling grant #1. In some embodiments of the present application, the SL scheduling grant #2 may also indicate a power boosting operation for UE-2 to increase success probability of SL transmission. The UE-2 may receive the scheduling grant #2 before SS #2 in slot #m.

In the slot #m, the BS may also transmit a sidelink pre-emption indication message to UE-1 to indicate at least one second set of resources (e.g., SS #2, SS #3 and SS #4) is pre-empted. The sidelink pre-emption indication message may include an SL-PI as illustrated in the above embodiments. In such embodiments, the UE-1 cannot receive the sidelink pre-emption indication message before the transmission in slot #m, but may receive the sidelink pre-emption indication message during slot #m, e.g., before SS #2 in slot #m.

In such embodiments, in addition to the SL-PI, the sidelink pre-emption indication message may also include an SL puncture indication. The SL puncture indication may indicate UE-1 to puncture its intended SL transmission in preempted sub-slots as indicated by SL-PI.

Then, after receiving the scheduling grant #2 before SS #2 in slot #m, UE-2 may perform the sidelink transmission on the SS #2, SS #3 and SS #4 in slot #m.

Although the UE-1 cannot receive the sidelink pre-emption indication message at the beginning of transmission on slot #m, the UE-1 may receive the sidelink pre-emption indication message before SS #2. If UE-1 can successfully decode the sidelink pre-emption indication message before SS #2 (e.g., in SS #1) of Slot #m, the UE-1 may puncture an intended SL transmission in the at least one second set of resources (e.g., SS #2, SS #3 and SS #4).

In the embodiments of FIG. 13, the UE-1 uses a CBG-based transmission. Accordingly, puncturing the intended SL transmission may refer to puncturing all the CBGs in SS #2, SS #3 and SS #4.

For the punctured CBGs in SS #2, SS #3 and SS #4 in slot #m, the UE-1 may perform the retransmissions of the punctured CBGs in slot #m+1 and/or slot #m+2.

In some embodiments, the SL-PI can also facilitate the UE to do retransmission decision on succeeding retransmission resources. For example, the UE may determine to perform a retransmission of an SL transmission in one or more sub-slots in slot #m based on the SL-PI.

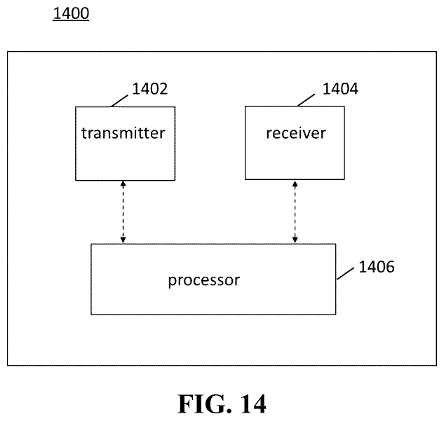

FIG. 14 illustrates a simplified block diagram of an exemplary apparatus for resource allocation according to some embodiments of the present application. In some embodiments, the apparatus 1400 may be or include at least part of a UE (e.g., UE 102a or UE 102b in FIG. 1). In some other embodiments, the apparatus 1400 may be or include at least part of a BS (e.g., BS 101 in FIG. 1).

Referring to FIG. 14, the apparatus 1400 may include at least one transmitter 1402, at least one receiver 1404, and at least one processor 1406. The at least one transmitter 1402 is coupled to the at least one processor 1406, and the at least one receiver 1404 is coupled to the at least one processor 1406.

Although in this figure, elements such as the transmitter 1402, the receiver 1404, and the processor 1406 are illustrated in the singular, the plural is contemplated unless a limitation to the singular is explicitly stated. In some embodiments of the present application, the transmitter 1402 and the receiver 1404 may be combined to one device, such as a transceiver. In some embodiments of the present application, the apparatus 1400 may further include an input device, a memory, and/or other components. The transmitter 1402, the receiver 1404, and the processor 1406 may be configured to perform any of the methods described herein (e.g., the method described with respect to any of FIGS. 5-13).

According to some embodiments of the present application, the apparatus 1400 may be a BS. In some embodiments of the present application, the transmitter 1402 is configured to transmit a scheduling grant associated with a resource pool to a UE, wherein the scheduling grant indicates a first set of resources for a SL transmission; and transmit a sidelink pre-emption indication message to the UE, wherein the sidelink pre-emption indication message comprises a SL-PI indicating that at least one second set of resources of the first set of resources is pre-empted, wherein each second set of resources is represented by a pair of sub-slot(s) and sub-channel(s).

In some embodiments of the present application, a sub-slot pattern of the sub-slot(s) associated with a second set of resources is indicated by a sub-slot pattern index which is included in a resource pool configuration for the resource pool.

In some embodiments of the present application, the transmitter 1402 is further configured to transmit a parameter indicating a number of consecutive sub-channels included in a second set of resources.

In some embodiments of the present application, the parameter indicating the number of consecutive sub-channels is transmitted in DCI carrying the sidelink pre-emption indication message or in a resource pool configuration for the resource pool.

In some embodiments of the present application, the transmitter 1402 is further configured to transmit a parameter indicating a number of consecutive sub-slots included in a second set of resources.

In some embodiments of the present application, the parameter indicating the number of consecutive sub-slots is transmitted in DCI carrying the sidelink pre-emption indication message or in a resource pool configuration for the resource pool.

In some embodiments of the present application, the sidelink pre-emption indication message is transmitted in at least one of the following signalings: a UE-specific DCI for the UE; a group-common DCI for a group of UEs including the UE; a MAC CE; or a RRC signaling.

In some embodiments of the present application, the SL-PI is a bitmap, wherein each bit of the bitmap indicates whether a second set of resources is pre-empted.

In some embodiments of the present application, the SL-PI is at least one indication indicating the at least one second set of resources.

In some embodiments of the present application, the sidelink pre-emption indication message further comprises at least one of followings: an SL cancellation indication; a permitted power level for an intended SL transmission of the UE; or an SL puncture indication.

In some embodiments of the present application, each sub-slot is used to transmit integer number of CBGs of a TB from the UE.

In some embodiments of the present application, the transmitter 1402 is further configured to transmit a CBG transmission indication which indicates to enable or disable a CBG-based transmission for the resource pool.

In some embodiments of the present application, the CBG transmission indication is transmitted in DCI carrying the sidelink pre-emption indication message or in a resource pool configuration for the resource pool.

According to some other embodiments of the present application, the apparatus 1400 may be a UE. In some embodiments of the present application, the receive 1404 is configured to receive a scheduling grant associated with a resource pool, wherein the scheduling grant indicate a first set of resources for a SL transmission; and receive a sidelink pre-emption indication message, wherein the sidelink pre-emption indication message comprises a SL-PI indicating that at least one second set of resources of the first set of resources is pre-empted, wherein each second set of resources includes is represented by a pair of sub-slot(s) and sub-channel(s).

In some embodiments of the present application, a sub-slot pattern of the sub-slot(s) associated with a second set of resources is indicated by a sub-slot pattern index which is included in a resource pool configuration for the resource pool.

In some embodiments of the present application, the receiver 1404 is further configured to receive a parameter indicating a number of consecutive sub-channels included in a second set of resources.

In some embodiments of the present application, the parameter indicating the number of consecutive sub-channels is received in DCI carrying the sidelink pre-emption indication message or in a resource pool configuration for the resource pool.

In some embodiments of the present application, the receiver 1404 is further configured to receive a parameter indicating a number of consecutive sub-slots included in a second set of resources.

In some embodiments of the present application, the parameter indicating the number of consecutive sub-slots is received in DCI carrying the sidelink pre-emption indication message or in a resource pool configuration for the resource pool.

In some embodiments of the present application, the sidelink pre-emption indication message is received in at least one of the following signalings: a UE-specific DCI for the UE; a group-common DCI for a group of UEs including the UE; a MAC CE; or a RRC signaling.

In some embodiments of the present application, the SL-PI is a bitmap, wherein each bit of the bitmap indicates whether a second set of resources is pre-empted.

In some embodiments of the present application, the SL-PI is at least one indication indicating the at least one second set of resources.

In some embodiments of the present application, each sub-slot is used to transmit integer number of CBGs of a TB from the UE.

In some embodiments of the present application, the receiver 1404 is further configured to transmit a CBG transmission indication which indicates to enable or disable a CBG-based transmission for the resource pool.

In some embodiments of the present application, the CBG transmission indication is received in DCI carrying the sidelink pre-emption indication message or in a resource pool configuration for the resource pool.

In some embodiments of the present application, the sidelink pre-emption indication message further comprises at least one of followings: an SL cancellation indication; a permitted power level for an intended SL transmission of the UE; or an SL puncture indication.

In some embodiments of the present application, in response to receiving the SL cancellation indication, the processor 1406 is further configured to: cancel an intended SL transmission of the UE in at least one slot including the at least one second set of resources.

In some embodiments of the present application, in response to receiving the permitted power level, the transmitter 1402 is further configured to: transmit an intended SL transmission of the UE in at least one slot including the at least one second set of resources based on the permitted power level.

In some embodiments of the present application, the processor 1406 is further configured to determine to perform a retransmission of an SL transmission based on the SL-PI.

In some embodiments of the present application, in response to receipt of the SL cancellation indication, the processor 1406 is further configured to: cancel an intended SL transmission in the at least one second set of resources.

In some embodiments of the present application, in response to receipt the permitted power level, the transmitter 1402 is further configured to: transmit an intended SL transmission in the at least one second set of resources based on the permitted power level.

In some embodiments of the present application, in response to receipt of the SL puncture indication, the processor 1406 is further configured to: puncture an intended SL transmission of the UE in the at least one second set of resources.

In some embodiments of the present application, the apparatus 1400 may further include at least one non-transitory computer-readable medium. In some embodiments of the present application, the non-transitory computer-readable medium may have stored thereon computer-executable instructions to cause the processor 1406 to implement any of the methods as described above. For example, the computer-executable instructions, when executed, may cause the processor 1406 to interact with the transmitter 1402 and/or the receiver 1404, so as to perform operations of the methods, e.g., as described with respect to FIGS. 5-13.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus of resource allocation for SL communication, including a processor and a memory. Computer programmable instructions for implementing a method of resource allocation for SL communication are stored in the memory, and the processor is configured to perform the computer programmable instructions to implement the method of resource allocation for SL communication. The method of resource allocation for SL communication may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method of resource allocation for SL communication according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A base station (BS), comprising:
at least one memory; and
at least one processor coupled with the at least one memory and configured to cause the BS to:
transmit a scheduling grant associated with a resource pool to a user equipment (UE), wherein the scheduling grant indicates a first set of resources for a sidelink (SL) transmission; and
transmit a sidelink pre-emption indication message to the UE, wherein the sidelink pre-emption indication message comprises a sidelink pre-emption indicator (SL-PI) indicating that at least one second set of resources of the first set of resources is pre-empted, wherein each second set of resources is represented by a pair of sub-slots and sub-channels.

2. The BS of claim 1, wherein a sub-slot pattern of the sub-slots associated with the at least one second set of resources is indicated by a sub-slot pattern index that is included in a resource pool configuration for the resource pool.

3. The BS of claim 1, wherein the at least one processor is further configured to cause the BS to transmit a parameter indicating a number of consecutive sub-channels included in the at least one second set of resources.

4. The BS of claim 1, wherein the at least one processor is further configured to cause the BS to transmit a parameter indicating a number of consecutive sub-slots included in the at least one second set of resources.

5. The BS of claim 3, wherein the parameter is transmitted in downlink control information (DCI) carrying the sidelink pre-emption indication message or in a resource pool configuration for the resource pool.

6. The BS of claim 1, wherein the sidelink pre-emption indication message is transmitted in at least one of the following signalings:
a UE-specific DCI for the UE;
a group-common DCI for a group of UEs including the UE;
a medium access control (MAC) control element (CE); or
a radio resource control (RRC) signaling.

7. The BS of claim 1, wherein the SL-PI is a bitmap, wherein each bit of the bitmap indicates whether the at least one second set of resources is pre-empted.

8. The BS of claim 1, wherein the SL-PI is at least one indication indicating the at least one second set of resources.

9. The BS of claim 1, wherein the sidelink pre-emption indication message further comprises at least one of:
an SL cancellation indication;
a permitted power level for an intended SL transmission of the UE; or
an SL puncture indication.

10. The BS of claim 1, wherein each sub-slot is used to transmit an integer number of code block groups (CBGs) of a transport block (TB) from the UE.

11. The BS of claim 1, wherein the at least one processor is further configured to cause the BS to transmit a CBG transmission indication that indicates to enable or disable a CBG-based transmission for the resource pool.

12. The BS of claim 11, wherein the CBG transmission indication is transmitted in DCI carrying the sidelink pre-emption indication message or in a resource pool configuration for the resource pool.

13. A user equipment (UE), comprising:
at least one memory; and
at least one processor coupled with the at least one memory and configured to cause the BS to:
receive a scheduling grant associated with a resource pool, wherein the scheduling grant indicate a first set of resources for a sidelink (SL) transmission; and
receive a sidelink pre-emption indication message, wherein the sidelink pre-emption indication message comprises a sidelink pre-emption indicator (SL-PI) indicating that at least one second set of resources of the first set of resources is pre-empted, wherein each second set of resources is represented by a pair of sub-slots and sub-channels.

14. (canceled)

15. A method performed by a user equipment (UE), the method comprising:
receiving a scheduling grant associated with a resource pool, wherein the scheduling grant indicates a first set of resources for a sidelink (SL) transmission; and
receiving a sidelink pre-emption indication message, wherein the sidelink pre-emption indication message comprises a sidelink pre-emption indicator (SL-PI) indicating that at least one second set of resources of the first set of resources is pre-empted, wherein each second set of resources is represented by a pair of sub-slots and sub-channels.

16. The BS of claim 4, wherein the parameter is transmitted in downlink control information (DCI) carrying the sidelink pre-emption indication message or in a resource pool configuration for the resource pool.

17. A method performed by a base station (BS), comprising:
transmitting a scheduling grant associated with a resource pool to a user equipment (UE), wherein the scheduling grant indicates a first set of resources for a sidelink (SL) transmission; and
transmitting a sidelink pre-emption indication message to the UE, wherein the sidelink pre-emption indication message comprises a sidelink pre-emption indicator (SL-PI) indicating that at least one second set of resources of the first set of resources is pre-empted, wherein each second set of resources is represented by a pair of sub-slot and sub-channel.

18. The method of claim 17, wherein a sub-slot pattern of the sub-slots associated with the at least one second set of resources is indicated by a sub-slot pattern index that is included in a resource pool configuration for the resource pool.

19. The method of claim 17, further comprising causing the BS to transmit a parameter indicating a number of consecutive sub-channels included in the at least one second set of resources.

20. The method of claim 17, wherein the SL-PI is a bitmap, wherein each bit of the bitmap indicates whether the at least one second set of resources is pre-empted.

21. The method of claim 18, wherein the SL-PI is at least one indication indicating the at least one second set of resources.
